(19) United States
(12) Patent Application Publication
(10) Pub. No.: US 2011/0260939 A1
(43) Pub. Date: Oct. 27, 2011

(54) DISTRIBUTED MULTIBAND ANTENNA AND METHODS

(76) Inventors: Heikki Korva, Tupos (FI); Petteri Annamaa, Oulunsalo (FI); Ari Raappana, Kello (FI)

(21) Appl. No.: 12/764,826

(22) Filed: Apr. 21, 2010

(51) Int. Cl. H01Q 21/30

(52) U.S. Cl. 343/725

(57) ABSTRACT

A distributed multiband antenna intended for radio devices, and methods for designing manufacturing the same. In one embodiment, a planar inverted-F antenna (PIFA) configured to operate in a high-frequency band, and a matched monopole configured to operate in a low-frequency band, are used within a handheld mobile device (e.g., cellular telephone). The two antennas are placed on substantially opposing regions of the portable device. The use of a separate low-frequency antenna element facilitates frequency-specific antenna matching, and therefore improves the overall performance of the multiband antenna. The use of high-band PIFA reduces antenna volume, and enables a smaller device housing structure while also reducing signal losses in the high frequency band. These attributes also advantageously facilitate compliance with specific absorption rate (SAR) tests; e.g., in the immediate proximity of hand and head “phantoms” as mandated under CTIA regulations. Matching of the low-frequency band monopole antenna is further described.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE INVENTION

The present invention relates generally to antennas for use in wireless or portable radio devices, and more particularly in one exemplary aspect to a spatially distributed multiband antenna, and methods of utilizing the same.

### 2. DESCRIPTION OF RELATED TECHNOLOGY

Internal antennas are an element found in most modern radio devices, such as mobile computers, mobile phones, Blackberry® devices, smartphones, personal digital assistants (PDAs), or other personal communication devices (PCD). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Internal antennas are commonly constructed to comprise at least a part of a printed wired board (PWB) assembly, also commonly referred to as the printed circuit board (PCB). One antenna type that is commonly used in wireless applications is the inverted-F antenna (IFA).

### Planar Inverted-F Antenna

The inverted-F antenna is a variant of the monopole, wherein the top section has been folded down so as to be parallel with the ground plane. This is typically done to reduce the size of the antenna while maintaining a resonant trace length. Planar inverted-F antenna (PIFA) is a variation of linear inverted-F antenna, wherein the wire radiator element is replaced by a plate to expand the antenna operating bandwidth. A typical planar inverted-F antenna 100 in accordance with prior art, shown in FIG. 1A, includes a rectangular planar element 110 (also referred to as the “upper arm”) located above a ground plane 102, and a short circuiting plate or pin 104 that connects the top plate 110 to the ground point 114. The feed structure 106 is placed from the ground plane feed point 116 to the planar element 100 of the PIFA.

FIG. 1B shows a top elevation view of the PIFA structure 130, wherein the antenna elements are arranged in a coplanar fashion as during fabrication. To the left of the feed point 116 (as shown in FIG. 1B), the upper planar element is shorted to the ground plane 102. The feed point 116 is closer to the shorting pin 104 than to the open end of the upper plane element 118. The fabrication-stage antenna structure 130 shown in FIG. 1B is bent at locations 120 to produce functional PIFA configuration 100 shown in FIG. 1A.

The optimal length of an ideal inverted-F antenna radiating element is a quarter of a wavelength λ that corresponds to the operating center frequency fₒ. However, the size of the PIFA planar element 110 (length L 108 and width W 118) is commonly chosen such that:

L+W=λ/4 Eqn. (1)

and therefore is inversely proportional to the operating frequency fₒ

$${f}_{0} = \frac{c}{2 L \sqrt{{ɛ}_{r}}} . \qquad Eqn . ( 2 )$$

Here, c is the speed of light and ∈ᵣ is dielectric permittivity of the substrate material. Typically, the width of the ground plane 114 matches the PIFA length 108, and the ground plane length 112 is approximately one quarter-wavelength. When the width of the ground plane is smaller than a quarter-wavelength, the bandwidth and efficiency of the PIFA decrease. Hence, typically inverted-F antennas require printed circuit board (PCB) ground plane length is roughly one quarter (λ/4) of the operating wavelength

The height of the PIFA 101 above the ground plane is commonly a fraction of the wavelength. Therefore, PIFA operating at lower frequencies require taller antenna configuration that in turn increase the thickness of the radio device body assembly. The radiation properties and impedance of PIFA are not a strong function of the height. This parallel section introduces capacitance to the input impedance of the antenna, which is compensated by implementing a short-circuit stub. The end of the stub is connected to the ground plane through a via (not shown). The polarization of PIFA shown in FIG. 1A is vertical, and the radiation pattern resembles the shape of a ‘donut’, with the main axis oriented vertically.

As the operating frequency decreases, the PIFA antenna size increases according to Eqn. (2) in order to maintain operating efficiency. Therefore, a multi-band (e.g., dual-band) PIFA, operating in both upper and lower bands, requires a larger volume and height in order to meet the lower-band frequency requirements typical of mobile communications (e.g., 800-900 MHz). To reduce the size of mobile devices operating at these lower frequencies, ordinary monopole antennas are commonly used instead of a PIFA.

Several methods may used to control the PIFA resonance frequency, include, inter alia, (i) the use of open slots that reduce the frequency, (ii) altering the width of the planar element, and/or (iii) altering the width of the short circuit plate of the PIFA. For instance, resonant frequency decreases with a decrease in short circuit plate width.

One method of reducing PIFA size is simply by shortening the antenna. However, this requires the use of capacitive loading to compensate for the reactive component of the impedance that arises due to the shortened antenna structure. Capacitive loading allows reduction in the resonance length from λ/4 to less than λ/8, at the expense of bandwidth and good matching (efficiency). The capacitive load can be produced for example by adding a plate (parallel to the ground) to produce a parallel plate capacitor.

One of the substantial limitations of PIFA for wireless commercial applications is its narrow bandwidth. Various techniques are typically used to increase PIFA bandwidth such as, inter alia, reducing the size of the ground plane, adjusting the location and the spacing between two shorting posts, reducing the quality factor of the resonator structure (and to increase the bandwidth), utilizing stacked elements, placing slits at the ground plane edges, and use of parasitic resonators with resonant lengths close to the main resonance frequency.

The ground plane of the PIFA plays a significant role in its operation. Excitation of currents in the IFA causes excitation of currents in the ground plane. The resulting electromagnetic field is formed by the interaction of the PIFA and an “image” of itself below the ground plane. As a result, a PIFA has significant currents that flow on the undersurface of the planar element and the ground plane, as compared to the field on the upper surface of the element. This phenomenon makes the PIFA less susceptible to interference from external objects (e.g., a mobile device operator's hand/head) that typically affect the performance characteristics of monopole antennas.

### Compliance Testing of Wireless Devices

Almost all wireless devices that are offered for sale worldwide are subject to government regulations that mandate specific absorption (SAR) tests to be performed with each radio-emitting device. For example, the CTIA3.0 specification requires SAR measurements with mobile devices to be performed in: (i) free space; and (ii) proximate to a “phantom” head and hand, so as to simulate the real-world operation.

Referring now to FIG. 1C prior art CTIA SAR test configuration 150 with head phantom is shown. The head phantom 152 is constructed to simulate a human head, and features a reference plane 162 contour that passes through the mouth area 160. The mobile device 156 is positioned against the phantom ear area at an angle 164 to the head phantom 152 vertical axis. The mobile device 156 is spaced from the hand phantom 154 by a palm spacer 158. The test angle 164 is typically about 6 degrees.

FIG. 1D depicts a prior art CTIA SAR test configuration 170 for a mobile radio device 156 with a hand phantom 154. According to the CTIA 3.0 setup, the mobile device 156 is positioned along a center axis 176 of the palm spacer 158.

Prior art antenna solutions commonly address the multiband antenna requirements for mobile phones by implementing a single PIFA, or a single monopole antenna configured to operate in multiple frequency bands. This approach inherently has drawbacks, as PIFAs require larger size (height in particular), and hence occupy a large volume to reach the desired lower frequency of multiband operation. While monopole antennas typically perform well in the free space tests, their performance beside the aforementioned phantom head and hand is degraded, particularly at higher frequencies. However, the high-band PIFA antennas usually work better beside the phantom due to a ground plane between the antenna and the phantom.

While the height of a PIFA can be reduced by means of switching circuits, this approach increases complexity and cost. Although monopole antennas are generally smaller than a PIFA, a top-mounted monopole antenna performs poorly in CTIA tests proximate to the head phantom. Similarly, bottom mounted PIFA exhibit poor performance in CTIA tests proximate to the head phantom and hand phantom.

Therefore, based on the foregoing, there is a salient need for an improved multiband wireless antenna for use in mobile phones and other mobile radio devices that have reduced size, lower cost and improved performance in CTIA tests (and methods of utilizing the same).

### SUMMARY OF THE INVENTION

The present invention satisfies the foregoing needs by providing, inter alia, a space-efficient multiband antenna and methods of use.

In a first aspect of the invention, a multiband antenna assembly is disclosed. In one embodiment, the assembly has lower and an upper operating frequency bands, and is for use in a mobile radio device. The assembly in this embodiment comprises: a ground plane having a first and a second substantially opposing edges; a monopole antenna configured to operate in a first frequency band and being disposed proximate to the first edge; a planar inverted-F antenna (PIFA) configured to operate in a second frequency band and being disposed proximate to the second edge; and a feed apparatus configured to feed the monopole antenna and the PIFA elements. In one variant, the monopole antenna further comprises: a radiator element formed in a plane substantially perpendicular to the ground plane; a non-conductive slot formed within the radiator element; and a matching circuit. The matching circuit comprises: a feed point; a ground; a stripline coupled from the ground to the feed point; a tuning capacitor coupled to the ground and the stripline; and a feed pad coupled to the stripline via an inductor. The feed pad is further coupled to the radiator element; and the PIFA further comprises: a first planar radiator formed substantially parallel to the ground plane; a parasitic planar radiator formed substantially coplanar to the first planar radiator; a non-conductive slot formed inside within the first planar element; a first feed point coupled from the first planar radiator element to the feed apparatus; a ground point coupled from first planar radiator element to the ground plane; and a parasitic feed point coupled from the parasitic feed point to the ground plane.

In another embodiment, the antenna assembly comprises: a ground plane; a matching circuit comprising: a feed; a ground; a stripline coupled from the ground to the feed point; a feed pad coupled to the stripline via a coupling element; and a radiator element formed in a plane substantially perpendicular to the ground plane. The feed pad is further coupled to the radiator element.

In a second aspect of the invention, antenna apparatus is disclosed. In one embodiment, the apparatus comprises: a ground plane having a first and a second substantially opposing ends; a first antenna element operable in a first frequency band and disposed proximate to the first end; a matching circuit coupled to the first antenna element; a second antenna element configured to operate in an second frequency band and disposed proximate to the second end; and feed apparatus operably coupled to the first and the second antenna elements.

In a third aspect of the invention, a mobile communications device is disclosed. In one embodiment, the device has a multiband antenna apparatus contained substantially therein, and comprises: an exterior housing; a substrate disposed substantially within the housing; a ground plane having a first and a second substantially opposing ends, at least a portion of the ground plane disposed on the substrate; a first antenna element operable in a first frequency band and disposed proximate to the first end; a matching circuit coupled to the first antenna element; a second antenna element configured to operate in an second frequency band and disposed proximate to the second end; feed apparatus operably coupled to the first and the second antenna elements; and at least one radio frequency transceiver in operative communication with the feed apparatus.

In another embodiment, the mobile device comprises a reduced-size mobile radio device operable in a lower and an upper frequency bands. The device comprises an exterior housing and a multiband antenna assembly, the antenna assembly comprising a rectangular ground plane having first and second substantially opposing regions. The mobile radio device being configured according to the method comprising: placing a first antenna element configured to resonate in the upper frequency band proximate to a the first region; and placing a second antenna element configured to resonate in the lower frequency band proximate to the second region. The first antenna element comprises a planar inverted-F antenna (PIFA); and the act of placing the first antenna element effects reduction of the exterior housing size in at least one dimension.

In a fourth aspect of the invention, a method of operating multi-band antenna assembly is disclosed. In one embodiment, the antenna comprises first, second, and third antenna radiating elements, and at least first, second, and third feed points, the method comprising: selectively electrically coupling the first feed point to the first radiating element via a first circuit; or selectively electrically coupling the second feed point to the second radiating element via a second circuit; and the third feed point to the third radiating element via a third circuit. The first and second circuits effect the antenna assembly to operate in a first frequency band; and the third circuit effect the antenna assembly to operate in a second frequency band.

These and other embodiments, aspects, advantages, and features of the present invention will be set forth in part in the description which follows, and in part will become apparent to those skilled in the art by reference to the following description of the invention and referenced drawings or by practice of the invention.

### BRIEF DESCRIPTION OF THE DRAWINGS

The features, objectives, and advantages of the invention will become more apparent from the detailed description set forth below when taken in conjunction with the drawings, wherein:

FIG. 1A is a side elevation view of a typical PIFA in operational configuration.

FIG. 1B is a top elevation view showing an intermediate configuration of the PIFA of FIG. 1A.

FIG. 1C is a graphical illustration of a typical prior art CTIA 3.0 compliance measurement setup, depicting positioning of the unit under test with respect to the head phantom.

FIG. 1D is a graphical illustration of a typical prior art CTIA 3.0 measurement setup, depicting unit under test positioning with respect to the hand phantom.

FIG. 2A is a top elevation view of a distributed antenna configuration in accordance with one embodiment of the present invention.

FIG. 2B is a side elevation view of antenna configuration of FIG. 2A.

FIG. 2C is a graphical illustration of mobile telephone in accordance with a first embodiment of the present invention, positioned with respect to a CTIA hand phantom.

FIG. 3A is an isometric view of a section of a mobile phone, detailing a matched monopole low-band antenna structure in accordance with one embodiment of the present invention.

FIG. 3B is a top plan view of the low-band antenna structure of FIG. 3A.

FIG. 4A is an isometric of a mobile phone, detailing a high-band PIFA antenna in accordance with another embodiment of the present invention.

FIG. 4B is a top plan view of the PIFA antenna structure of FIG. 4A.

FIG. 5 is a plot of measured free space input return loss for various exemplary low-band and high-band antenna configurations according to the present invention.

FIG. 6A is a plot of measured free space efficiency for the low-band matched monopole antenna configuration of FIG. 3B.

FIG. 6B is a plot of measured free space efficiency for the high-band PIFA antenna configuration of FIG. 4B.

FIG. 7A is a plot of total efficiency (measured in the high-frequency band proximate to a head phantom) for the low-band matched monopole antenna configuration of FIG. 3B.

FIG. 7B is a plot of total efficiency (measured in the high-frequency band proximate to a head phantom) for the high-band PIFA antenna configuration of FIG. 4B.

FIG. 8A is a plot of total efficiency (measured in the high-frequency band proximate to head and hand phantoms) for the following antenna configurations: (i) the distributed antenna configuration of FIG. 2A; and (ii) a typical prior art bottom mounted monopole antenna.

FIG. 8B is a plot of measured figure-of-merit (FOM) of the distributed antenna configuration of FIG. 2A, as compared with a typical prior art bottom mounted monopole antenna.

All Figures disclosed herein are © Copyright 2010 Pulse Finland Oy. All rights reserved.

### DETAILED DESCRIPTION OF THE PREFERRED EMBODIMENT

Reference is now made to the drawings wherein like numerals refer to like parts throughout.

The terms “antenna,” “antenna system,” and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer to without limitation any frequency range for communicating signals. Such signals may be communicated pursuant to one or more standards or wireless air interfaces.

As used herein, the terms “mobile device”, “client device”, and “end user device” include, but are not limited to, personal computers (PCs) and minicomputers, whether desktop, laptop, or otherwise, set-top boxes, personal digital assistants (PDAs), handheld computers, personal communicators, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “feed,” “RF feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems, millimeter wave or microwave systems, optical, acoustic, and infrared (i.e., IrDA).

### Overview

The present invention provides, in one salient aspect, an antenna apparatus and mobile radio device with improved CTIA compliance, and methods for tuning and utilizing the same. In one embodiment, the mobile radio device comprises two separate antennas placed towards the opposing edges of the mobile device: (i) a top-mounted PIFA antenna operating in an upper-frequency band; and (ii) a bottom-mounted monopole antenna with matching circuit, for operating in a lower-frequency band.

The two individual antennas are designed to have best available performance in their specific operating band. By utilizing a distributed (i.e., substantially separated) antenna structure, the volume needed for the low-band antenna is reduced, while better performance (e.g., compliance with CTIA 3.0 specifications) is achieved at higher frequencies.

In one implementation, each antenna utilizes a separate feed. In an alternate embodiment, a single multi-feed transceiver is configured to provide feed to both antennas. The phone chassis acts as a common ground plane for both antennas.

A method for tuning one or more antennas in a mobile radio device is also disclosed. The method in one embodiment comprises forming one or more slots within the antenna radiator element so as to increase the effective electric length of the radiator, and thus facilitate antenna tuning to the desired frequency of operation.

A method for matching a monopole antenna for operation in a lower frequency band is also disclosed. In one embodiment, the method comprises using a low-frequency matching circuit to improve antenna impedance matching and radiation efficiency.

### DETAILED DESCRIPTION OF EXEMPLARY EMBODIMENTS

Detailed descriptions of the various embodiments and variants of the apparatus and methods of the invention are now provided. While primarily discussed in the context of mobile devices, the various apparatus and methodologies discussed herein are not so limited. In fact, many of the apparatus and methodologies described herein are useful in any number of complex antennas, whether associated with mobile or fixed location devices, that can benefit from the distributed antenna methodologies and apparatus described herein.

### Exemplary Antenna Apparatus

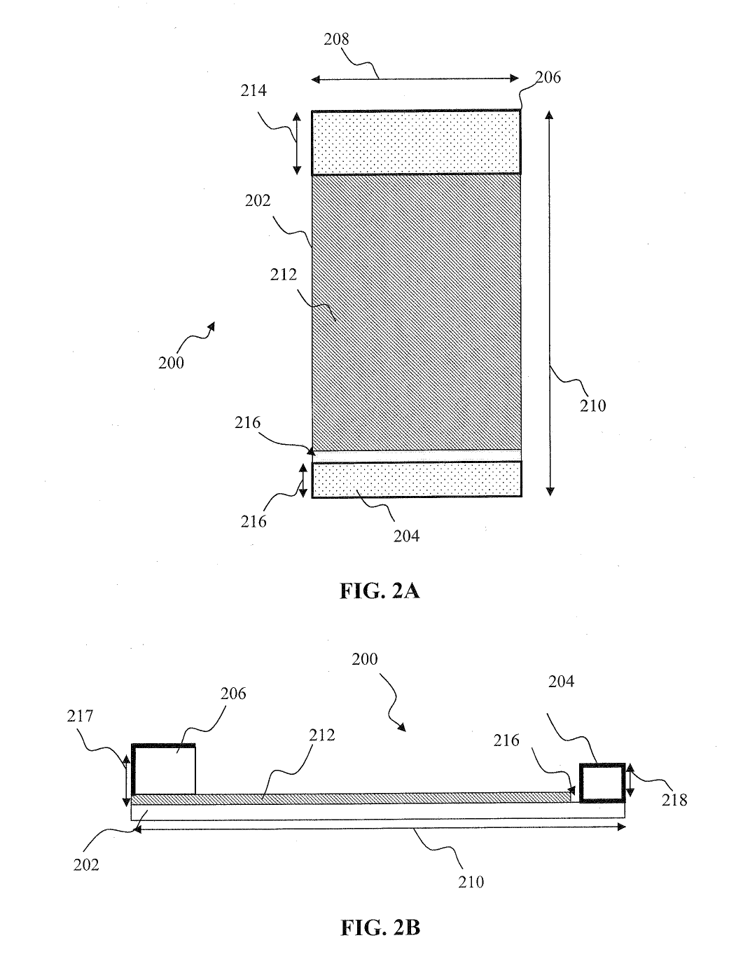

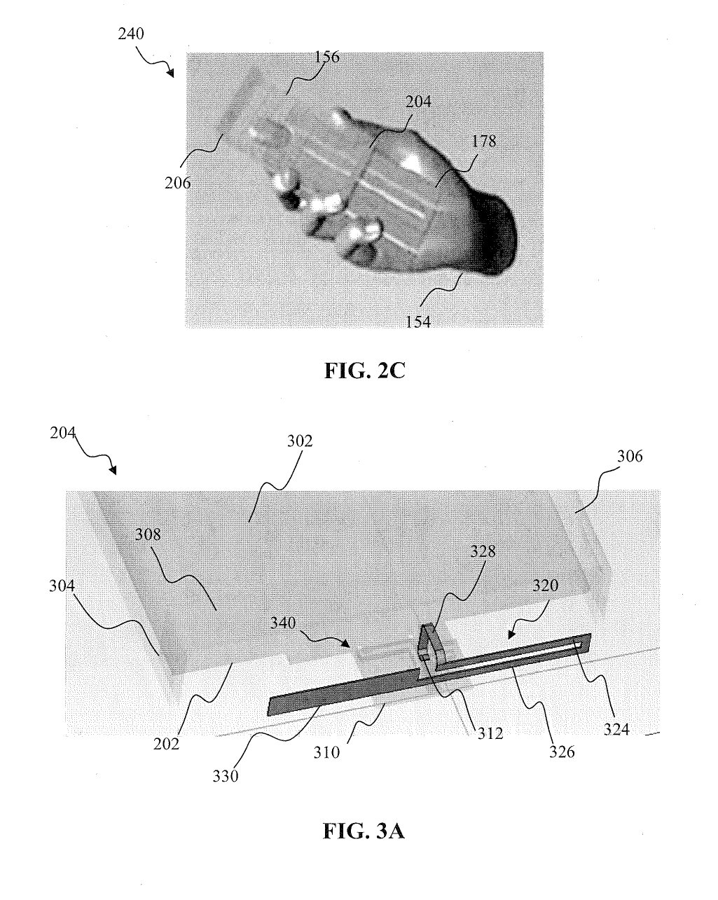

Referring now to FIG. 2A through FIG. 8B, exemplary embodiments of the mobile radio antenna apparatus of the invention (and their associated performance) are described in detail.

It will be appreciated that while these exemplary embodiments of the antenna apparatus of the invention are implemented using a PIFA and a monopole antenna (selected in these embodiments for their desirable attributes and performance), the invention is in no way limited to PIFA and/or monopole antenna-based configurations, and in fact can be implemented using other technologies, such as patch or microstrip.

Referring now to FIG. 2A, one embodiment of a mobile radio device printed circuit board comprising (PCB) a distributed multiband antenna configuration is shown. The PCB 200 comprises a rectangular substrate element 202 having a width 208 and a length 210, with a conductive coating deposited on the front planar face of the substrate element, so as to form a ground plane 212. An inverted-F planar antenna 206 is disposed proximate to one (top) end of the PCB 200. The PIFA 206 is configured to operate in the upper frequency band (here, 1900 MHz), and has a width 214 and a length 208. A lower-band (here, 900 MHz) monopole antenna 204 is disposed proximate the opposite end of the PCB 200 from the PIFA element 206. The ground plane 212 extends from the top edge of the substrate to the bottom monopole 204. For optimal operation, the monopole antenna 204 requires a clearance area 216 from the ground plane.

FIG. 2B illustrates a side view of the distributed antenna configuration 200 of FIG. 2A taken along the line 2A-2A. The vertical dimension (height) 217 of the high-band PIFA element 206 and height 218 of the monopole antenna element 204, are also shown.

The exemplary PCB 200 of FIGS. 2A-2B comprises a rectangular shape of about 110 mm (4.3 in.) in length, and 50 mm (2.0 in.) in width. The dimensions of the exemplary antennas are as follows: the upper-band (PIFA) is 7 mm (0.3 in) high and 13 mm (0.5 in) wide, while the lower-band (monopole) is 6 mm (0.3 in) tall and 7 mm (0.3 in.) wide. As persons skilled in the art will appreciate, the dimensions given above may be modified as required by the particular application. While the majority of presently offered mobile phones and personal communication devices typically feature a bar (e.g., so-called “candy bar”) or a flip configuration with a rectangular outline, there are other designs that utilize other shapes (such as e.g., the Nokia 77XX Twist™, which uses a substantially square shape). Advantageously, the antenna(s) of the invention can readily be adopted for even these non-traditional shapes.

Referring now to FIG. 2C, a phantom hand CTIA test configuration is shown for a mobile radio device comprising a distributed antenna configuration according to the present invention. In the configuration shown in FIG. 2C, the high-band PIFA element 206 is advantageously spaced further from the hand phantom than prior art solutions, which improves antenna high-band performance. The low-band monopole element 204 is located proximate to the hand phantom 154. To compensate for potential degradation in antenna performance at lower frequencies due to proximity of external elements (such as the hand phantom), the antenna element 204 is outfitted with a matching circuit. Because the lower-band and the upper-band antenna elements are implemented separately (both mechanically and electrically separated from each other), the lower-band antenna matching only affects the low frequency portion, without affecting the operation of the high-frequency portion of the distributed antenna. In one embodiment, the electrical isolation between the lower-band and the upper-band antenna elements 204 and 206 is approximately 25 dB. This amount of isolation allows for better lower band and upper band antenna performance as the two antenna elements 204,206 are practically electrically independent from each other.

Using a distributed antenna configuration of the type described herein, the ground clearance area required for optimal antenna operation in lower frequency band (e.g., 900 MHz) can be in theory reduced. In an embodiment shown above in FIG. 2A the ground plane clearance is reduced from 10 mm to 7 mm, compared to having only a bottom mounted monopole antenna. Since the upper band antenna is moved to the other end region of the mobile device, the space that it occupied at the bottom end is available for other uses (or alternatively allows for a smaller device form factor in that area).

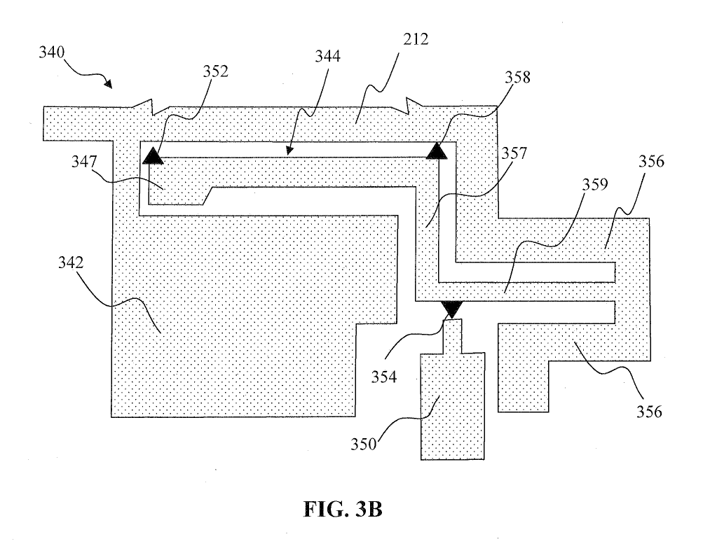

The detailed structure of the lower-band antenna 204, configured in accordance with the principles of the present invention, is shown in FIGS. 3A-3C. FIG. 3A presents an isometric view of an exemplary mobile radio device bottom section, with monopole antenna revealed. The device cover 302 (fabricated from any suitable material such as plastic, metal, or metal-coated plastic) is shown as being transparent so as to reveal the underlying support members 304, 306, 308 of the mobile device body assembly. In one embodiment, the members 304, 306, 308 are fabricated from plastic while other suitable materials can be used as well, e.g., metal, or metal-coated polymer. The low-band antenna assembly 204 comprises monopole radiator structure 320, and the corresponding matching circuit 340.

The lower-band plane radiator element 320 is in the illustrated embodiment oriented perpendicular to the mobile device PCB substrate 202, and is electrically coupled to the circuit 340 via the feed point 312. The matching circuit 340 is fabricated directly on a lower portion 310 of the PCB substrate 202. In one variant, the lower portion 310 of the PCB substrate is dimensioned so as to match the outer dimensions of the matching circuit 320, as shown in FIG. 3A, although this is not a requirement for practicing the invention.

The lower-band monopole antenna comprises a rectangular radiator end portion 320 and a plurality of stripline radiator elements 324, 326, 328. The striplines sections 324, 326 are arranged to from a non-conductive slot in the radiator plane. This slot can be used to form a higher resonance mode, to same feed point as the low band resonance, if required. The radiator elements 320, 324, 326, 328 are configured to increase the antenna effective electric length so as to permit operation in the low frequency band (here, 850 and 900 MHz), while minimizing the physical size occupied by the antenna assembly. The antenna 320 radiator is electrically coupled to the mobile radio device transceiver via the feed point 312. In order to reduce the overall volume occupied by the lower-band antenna 204, the element 328 is bent to conform to the shape of a plastic support carrier (not shown) that is placed underneath antenna radiating element, as shown in FIG. 3A, when it is installed in the mobile radio device.

FIG. 3B depicts the detailed structure of the exemplary embodiment of the matching circuit 340 used in conjunction with the lower-band antenna element 320 to form the lower-band matching monopole antenna assembly. The purpose of the matching circuit is used to increase bottom mounted monopole impedance antenna bandwidth. The matching circuit 340 comprises a ground element 342, a stripline 344 formed between ground elements 342, 356 and the ground plane 212. In one embodiment, the stripline 344 comprises a nonrectangular structure 347, although other shapes may be used consistent with the invention. The stripline 344 is coupled to the feed electronics at the feed point 352, and coupled to ground via a tuning capacitive element 358. By appropriately positioning the capacitive element 358 and/or changing the capacitance value a precise antenna circuit resonance tuning is achieved.

In an alternate embodiment, the stripline 344 may comprise one or more bends configured to create segments 357, 359. Although segments 357,359 are shown to form at a right angle other mutual orientations are possible, as can be appreciated by these skilled in the art. The position of the bends and the length of elements 357, 359 are selected to alter the resonance length of the antenna as required for more precise matching to the desired frequency band of operation.

The matching circuit 340 is coupled to the low-band antenna radiator element 320 via a low-band feeding pad 350. The pad 350 is coupled from the stripline 344 via an inductive element 354. In one embodiment the inductive element 354 comprises a serial coil.

The matching circuit 340 forms a parallel LC circuit, wherein the inductance is formed by the stripline 344 connection to ground and the capacitance is determined by the stripline 344 size and capacitive element 358 (e.g., lumped). It is appreciated that while a single capacitive element 358 is shown in the embodiment of FIG. 3B, multiple (i.e., two or more) components arranged in an electrically equivalent configuration may be used consistent with the present invention. Moreover, other types of capacitive elements may be used, such as, discrete (e.g., plastic film, mica, glass, or paper) capacitors, or chip capacitors. Myriad other capacitor configurations useful with the invention exist.

In one embodiment, the matching circuit 340 is formed by depositing a conductive coating onto a PCB substrate, and subsequently etching the required pattern, as shown in FIG. 3B. Other fabrication methods are anticipated for use as well, such as forming a separate flex circuit and attaching it to the PCB substrate.

The matching circuit 340 inter alia, (i) enables precise tuning of the low band monopole antenna to the desired frequency band; and (ii) provides accurate impedance matching to the feed structure of the transceiver. This advantageously improves low band antenna performance in phantom tests, and enables better compliance with CTIA requirements.

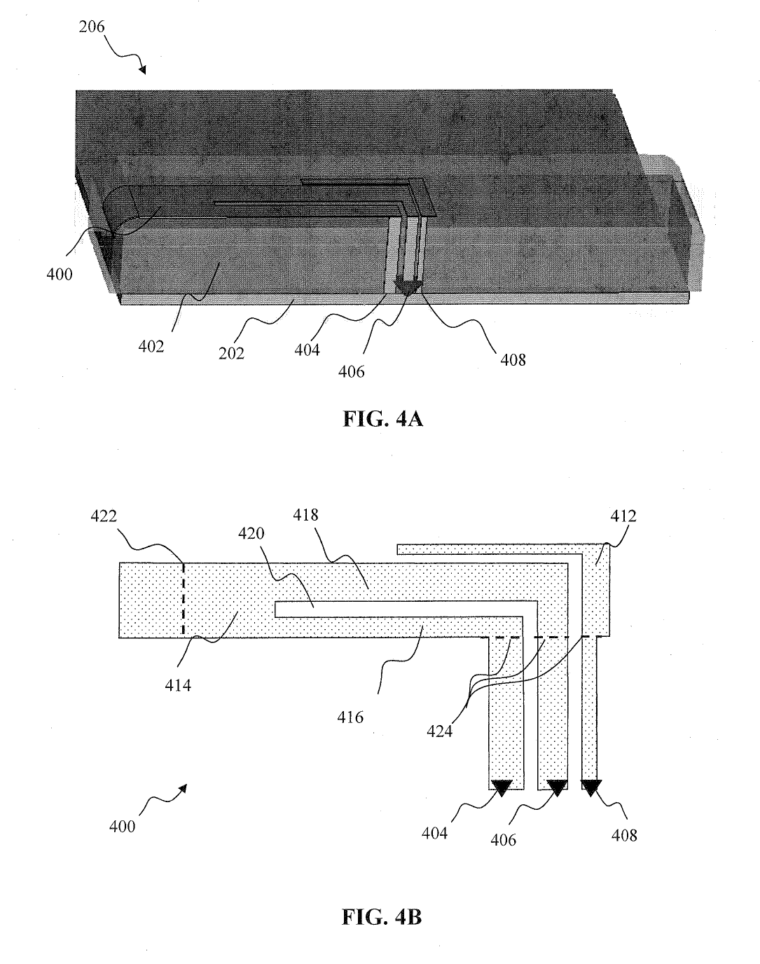

Referring now to FIG. 4A, the structure of one embodiment of the high-band planar inverted-F antenna element 206 is shown in detail. The high-band PIFA comprises planar radiating structure 400 deposited onto the substrate 402. The PIFA structure 206 is coupled to the ground plane at three points: the main high-band feed 406, the parasitic feed 408, and the ground point 404.

The exemplary PIFA planar element 400, shown in detail in FIG. 4B, comprises primary rectangular radiator portion 414, parasitic radiator 412, and a slot 420 formed between two lateral members of the radiator structure 416, 418.

In one embodiment, in order to reduce the overall volume occupied by the high-band antenna 206, the PIFA structure 400 is routed or bent along the lines 422, 424 so as to conform to the shape of the underlying substrate when installed in the mobile radio device, as shown in FIG. 4A.

In another embodiment, the PIFA structure 400 is formed by depositing a conductive coating onto the PCB substrate 402 and subsequently etching the pattern shown in FIG. 4A. Other fabrications methods are anticipated for use as well, such as forming a separate flex circuit and attaching it to the PCB substrate.

In one embodiment, the lower frequency band comprises a sub-GHz Global System for Mobile Communications (GSM) band (e.g., GSM710, GSM750, GSM850, GSM810, GSM900), while the higher band comprises a GSM1900, GSM1800, or PCS-1900 frequency band (e.g., 1.8 or 1.9 GHz).

In another embodiment, the low or high band comprises the Global Positioning System (GPS) frequency band, and the antenna is used for receiving GPS position signals for decoding by e.g., an internal receiver.

In another variant, the high-band comprises a WiFi or Bluetooth frequency band (e.g., approximately 2.4 GHz), and the lower band comprises GSM1900, GSM1800, or PCS1900 frequency band. As persons skilled in the art will appreciate, the frequency band composition given above may be modified as required by the particular application(s) desired. Moreover, the present invention contemplates yet additional antenna structures within a common device (e.g., tri-band or quad-band) where sufficient space and separation exists.

### Performance

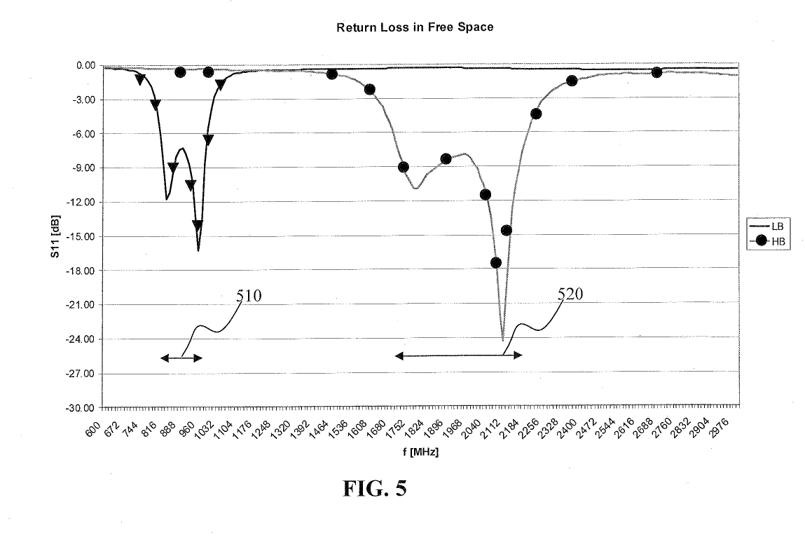

Referring now to FIGS. 5 through 8B, performance results of an exemplary distributed antenna constructed in accordance with the principles of the present invention are presented.

FIG. 5 shows a plot of free-space return loss S11 (in dB) as a function of frequency, measured with: (i) the lower-band antenna constructed in accordance with the embodiment depicted in FIG. 3A 204, and (ii) the upper-band antenna 206 constructed in accordance with the embodiment depicted FIG. 4A 206. The vertical lines of FIG. 5 denote the low band 510 and the high frequency band 520, respectively. Comparing the free space loss measured in the two frequency bands of interest, the upper-band antenna exhibits higher losses compared to the lower band, as expected.

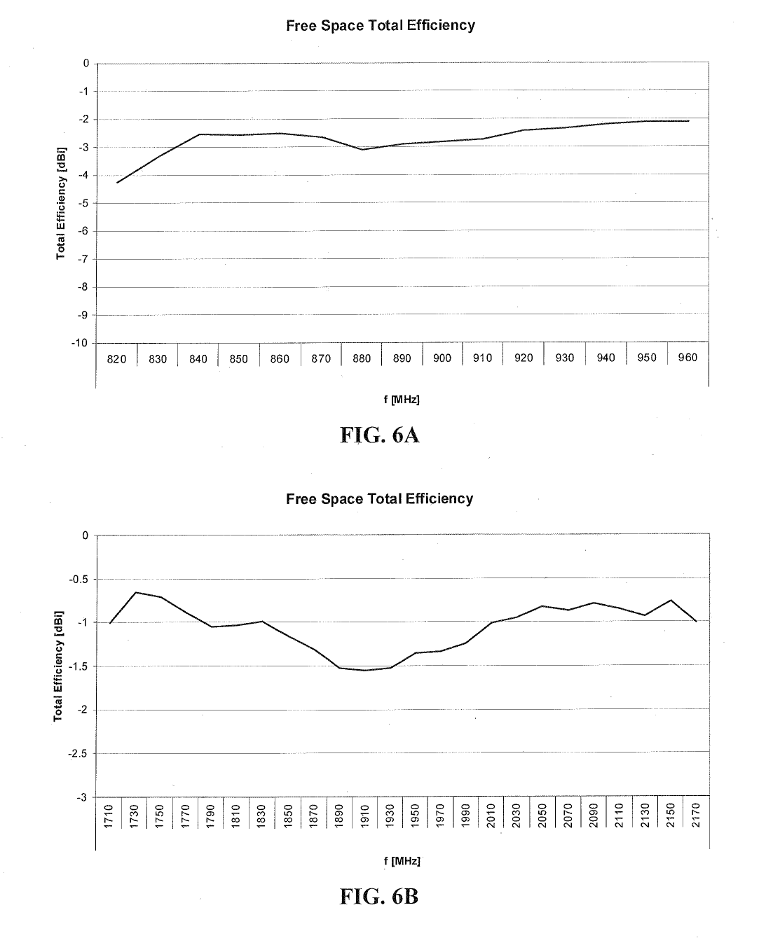

FIGS. 6A and 6B show data regarding measured free-space efficiency for the same two antennas as described above with respect to FIG. 5. The antenna efficiency (in dB) is defined as decimal logarithm of a ratio of radiated and input power:

$$AntennaEfficiency = 10 {log}_{10} ( \frac{Radiated Power}{Input Power} ) \qquad Eqn . ( 3 )$$

An efficiency of zero (0) dB corresponds to an ideal theoretical radiator, wherein all of the input power is radiated in the form of electromagnetic energy. The data in FIG. 6A demonstrate that the low-band monopole antenna of the invention achieves a total efficiency between −4 and −2 dB. The data in FIG. 6B, obtained with the high-band antenna, shows higher efficiency (between −1.5 and −0.5 dB) when compared to the low band data of FIG. 6A. Overall, the antenna embodiment of the present invention exhibits similar free-space performance, compared to a prior art design that uses a bottom-mounted monopole. The free-space efficiency describes the upper efficiency limit of the specific antenna, as it is achieved in the environment that is free from any interference that could potentially degrade antenna performance.

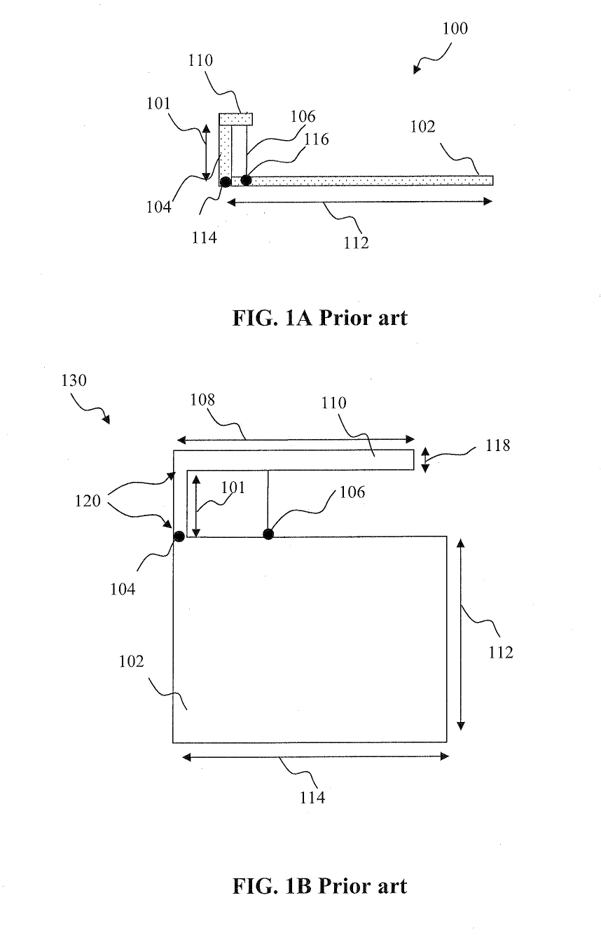

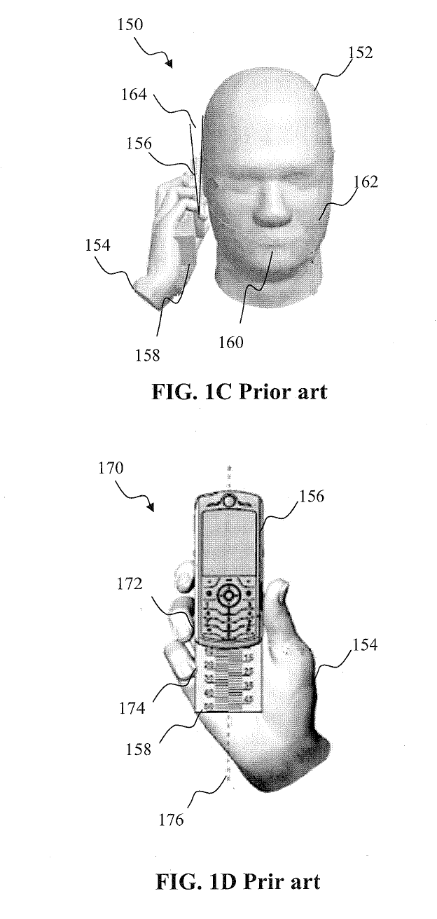

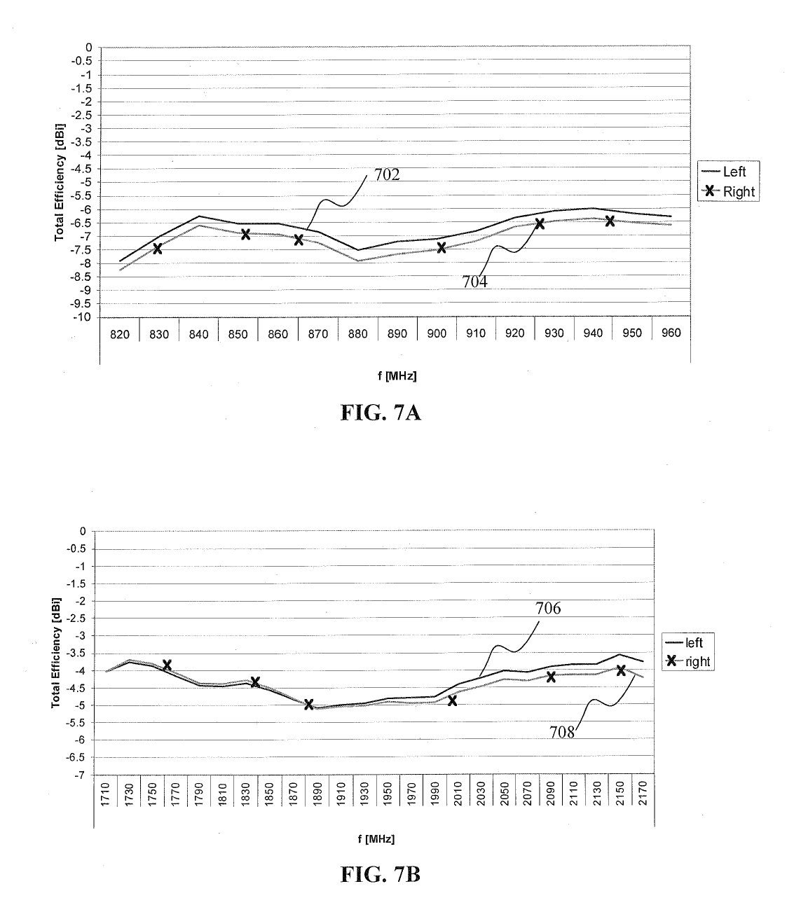

FIG. 7A and FIG. 7B present total efficiency data for the low band and high band antennas described above with respect to FIG. 5. The data presented in FIG. 7A and FIG. 7B are obtained proximate to the head phantom as mandated by the CTIA 3.0 regulations (see FIG. 1C above). The measurement results shown in FIG. 7A and FIG. 7B were obtained on both right and left sides of the head phantom. The curves 702, 706 correspond to the right side measurements; while the curves 704, 708 correspond to the left side measurements.

The lower-band efficiency data presented in FIG. 7A show slightly reduced antenna efficiency (by about 0.3 dB) measured on the right side across the whole lower frequency band, when compared to the left side measurements. The upper-band efficiency data presented in FIG. 7B show a very similar efficiency numbers measured on both the left and the right sides of the head phantom.

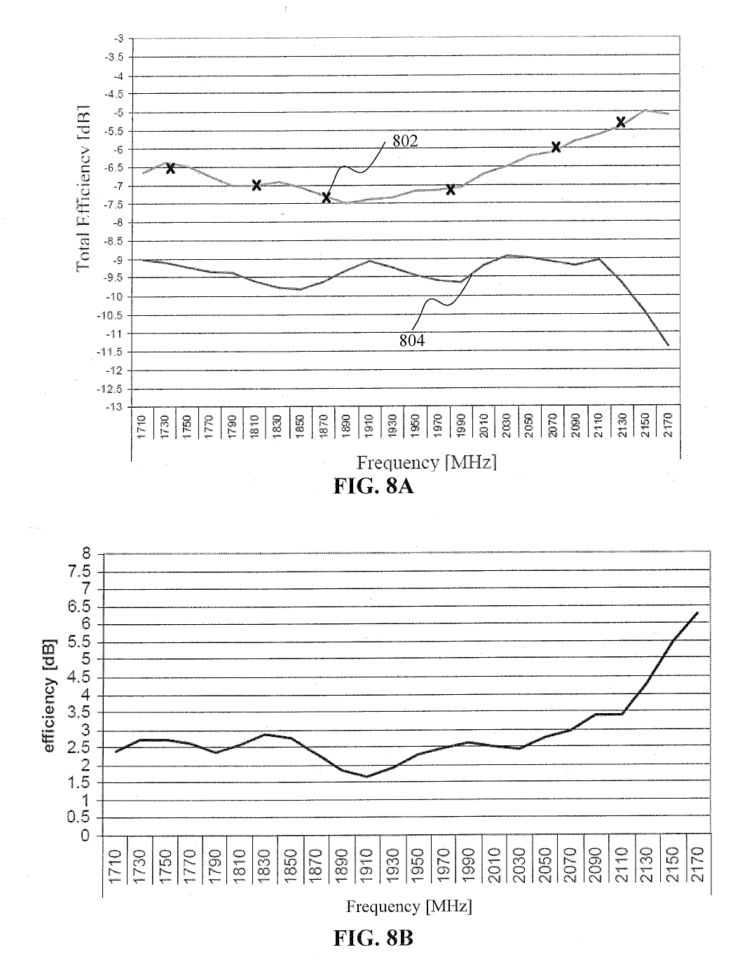

Referring now to FIG. 8A, the total efficiency measured in the high-frequency band proximate to the head and hand phantoms is shown for the following antenna configurations: (i) a distributed antenna configuration 200 of FIG. 2A 802; and (ii) bottom mounted monopole antenna according to the prior 804. FIG. 8B shows the difference dE between the efficiency measurements for the two antenna configurations described above with respect to FIG. 8A. Positive values of dE correspond to higher efficiency achieved with the distributed antenna configured in accordance with the present invention.

The data shown in FIG. 8B clearly demonstrate higher efficiency (between 2.5 and 6 dB) achieved with the distributed antenna proximate to the head and hand phantom when compared to the prior art design. This represents between 70 and 300% of additional power that is radiated (or received) by the distributed antenna compared to the prior art design. This increased efficiency can have profound implications for, inter alia, mobile devices with finite power sources (e.g., batteries), since appreciably less electrical power is required to produce the same radiated output energy. In addition, SAR compliance is easier to achieve, as a lower transmission power can be used with a more efficient antenna design (e.g., that shown in FIG. 4A-4B above).

Advantageously, the use of two separate antenna configurations for the upper (PIFA) and lower (matched monopole) bands as in the illustrated embodiments allows for optimization of antenna operation in each of the frequency bands independently from each other. The use high-frequency PIFA reduces the overall antenna assembly volume and height, compared to a single dual-band PIFA, and therefore enables a smaller and thinner mobile device structure. In addition, the use of a PIFA reduces signal loss and interference at higher frequencies when operating in proximity to the head and hand phantoms. Utilization of a monopole antenna, matched to operate in the lower frequency band, improves device performance when operating in the proximity to the head and hand phantoms as well. These, in turn, facilitate compliance with the CTIA regulations, with all of the foregoing attendant benefits.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A multiband antenna assembly having lower and an upper operating frequency bands, said assembly for use in a mobile radio device, said assembly comprising:
a ground plane having a first and a second substantially opposing edges;
a monopole antenna configured to operate in a first frequency band and being disposed proximate to said first edge;
a planar inverted-F antenna (PIFA) configured to operate in a second frequency band and being disposed proximate to said second edge; and
a feed apparatus configured to feed said monopole antenna and said PIFA elements;
wherein said monopole antenna further comprises:
a radiator element formed in a plane substantially perpendicular to said ground plane;
a non-conductive slot formed within said radiator element; and
a matching circuit comprising:
a feed point;
a ground;
a stripline coupled from said ground to said feed point;
a tuning capacitor coupled to said ground and said stripline; and
a feed pad coupled to said stripline via an inductor;
wherein said feed pad is further coupled to said radiator element; and
wherein said PIFA further comprises:
a first planar radiator formed substantially parallel to said ground plane;
a parasitic planar radiator formed substantially coplanar to said first planar radiator;
a non-conductive slot formed inside within said first planar element;
a first feed point coupled from said first planar radiator element to said feed apparatus;
a ground point coupled from first planar radiator element to said ground plane; and
a parasitic feed point coupled from said parasitic feed point to said ground plane.

2. The antenna assembly of claim 1, wherein center frequency of said lower frequency band is below 1600 MHz and center frequency of said upper frequency band is above 1700 MHz.

3. The antenna assembly of claim 2, wherein center said lower frequency band further comprises a global system for mobile communications (GSM) 900 band and said upper frequency band comprises GSM1800 band.

4. The antenna assembly of claim 3, wherein said lower frequency band comprises a global positioning system (GPS) band and said upper frequency band comprises GSM1900 frequency band.

5. Antenna apparatus, comprising:
a ground plane having a first and a second substantially opposing ends;
a first antenna element operable in a first frequency band and disposed proximate to said first end;
a matching circuit coupled to said first antenna element;
a second antenna element configured to operate in an second frequency band and disposed proximate to said second end; and
feed apparatus operably coupled to said first and said second antenna elements.

6. The apparatus of claim 5, wherein said first antenna element comprises a monopole antenna structure, and said first band is lower in frequency than said second band.

7. The apparatus of claim 6, wherein said matching circuit further comprises:
a feed point;
a ground;
a stripline coupled from said ground to said feed point; and
a feed pad coupled to said stripline via a coupling circuit.

8. The apparatus of claim 7, wherein said monopole antenna further comprises:
a capacitive element coupled between said ground and said stripline; and
a radiator element formed in a plane substantially perpendicular to said ground plane;
wherein said feed pad is further coupled to said radiator element.

9. The apparatus of claim 5, wherein said second antenna element comprises a planar inverted-F antenna (PIFA) structure.

10. The apparatus of claim 9, wherein said PIFA further comprises:
a first planar radiator formed substantially parallel to said ground plane;
a parasitic planar radiator formed substantially coplanar to said first planar radiator;
a non-conductive slot formed inside within said first planar element;
a first feed point coupled from said first planar radiator element to said feed apparatus;
a ground point coupled to first planar radiator element and said ground plane; and
a parasitic feed point coupled to said parasitic feed point and said ground plane.

11. The apparatus of claim 5, wherein a center frequency of said first frequency is below 1600 MHz, and a center frequency of said second frequency band is above 1700 MHz.

12. The apparatus of claim 11, wherein center said first frequency band comprises a Global System for Mobile Communications (GSM) 900 band, and said second frequency band comprises a GSM1800 band.

13. The apparatus of claim 5, wherein said first frequency band comprises a Global Positioning System (GPS) band, and said second frequency band comprises a WLAN frequency band of approximately 2.4 GHz.

14. The apparatus of claim 5, wherein said first and said second antenna comprise substantially different antenna types.

15. A mobile communications device having multiband antenna apparatus contained substantially therein, the device comprising:
an exterior housing;
a substrate disposed substantially within the housing;
a ground plane having a first and a second substantially opposing ends, at least a portion of the ground plane disposed on the substrate;
a first antenna element operable in a first frequency band and disposed proximate to said first end;
a matching circuit coupled to said first antenna element;
a second antenna element configured to operate in an second frequency band and disposed proximate to said second end;
feed apparatus operably coupled to said first and said second antenna elements; and
at least one radio frequency transceiver in operative communication with said feed apparatus.

16. The apparatus of claim 15, wherein said first antenna element comprises a monopole antenna structure, and said first band is lower in frequency than said second band.

17. The apparatus of claim 16, wherein said exterior housing is of the candy-bar type.

18. The apparatus of claim 16, wherein said exterior housing is of the flip-open type.

19. The apparatus of claim 15, wherein said first antenna element comprises a monopole-type antenna, and said second antenna element comprises a PIFA.

20. The apparatus of claim 19, wherein said monopole-type antenna is disposed substantially proximate to a microphone-bearing end of said device, and said PIFA is disposed substantially proximate to a speaker- or earpiece-bearing end of said device.

21. The apparatus of claim 15, wherein a center frequency of said first frequency is below 1600 MHz, and a center frequency of said second frequency band is above 1700 MHz.

22. The apparatus of claim 21, wherein center said first frequency band comprises a Global System for Mobile Communications (GSM) 900 band, and said second frequency band comprises a GSM1800 band.

23. The apparatus of claim 15, wherein said first frequency band comprises a Global Positioning System (GPS) band, and said second frequency band comprises a WLAN frequency band of approximately 2.4 GHz.

24. The apparatus of claim 16, wherein said first and said second antenna comprise substantially different antenna types.

25. A method of operating multi-band antenna assembly, the antenna comprising first, second, and third antenna radiating elements, and at least first, second, and third feed points, the method comprising:
selectively electrically coupling said first feed point to said first radiating element via a first circuit; or
selectively electrically coupling said second feed point to said second radiating element via a second circuit; and said third feed point to said third radiating element via a third circuit;
wherein the first and second circuits effect the antenna assembly to operate in a first frequency band; and
wherein the third circuit effect the antenna assembly to operate in a second frequency band.

26. The method of claim 25 further comprising the step of electrically matching the third radiating element to the second frequency band.

27. The method of claim 26, wherein matching comprises providing stripline configured to tune antenna resonance to the second frequency band.

28. The method of claim 25 further comprising the step of electrically isolating the first and the second radiating elements from the third radiating element.

29. An antenna assembly comprising:
a ground plane;
a matching circuit comprising:
a feed;
a ground;
a stripline coupled from said ground to said feed point;
a feed pad coupled to said stripline via a coupling element; and
a radiator element formed in a plane substantially perpendicular to said ground plane;
wherein said feed pad is further coupled to said radiator element.

30. The assembly of claim 29, wherein said matching circuit further comprises a capacitive element coupled from said ground to said stripline and configured to effect tuning of antenna resonance to a first frequency band.

31. The assembly of claim 29, wherein said coupling element comprises an inductive circuit.

32. The assembly of claim 7, wherein said coupling element comprises an inductive circuit.

33. The assembly of claim 8, wherein said capacitive element is configured to effect tuning of antenna resonance to a first frequency band.

34. A reduced-size mobile radio device operable in a lower and an upper frequency bands, said device comprising an exterior housing and a multiband antenna assembly, said antenna assembly comprising a rectangular ground plane having first and second substantially opposing regions, said mobile radio device being configured according to the method comprising:
placing a first antenna element configured to resonate in the upper frequency band proximate to a said first region; and
placing a second antenna element configured to resonate in the lower frequency band proximate to said second region;
wherein said first antenna element comprises a planar inverted-F antenna (PIFA); and
wherein the act of placing the first antenna element effects reduction of the exterior housing size in at least one dimension.
